(19) United States
(12) Patent Application Publication
(10) Pub. No.: US 2025/0027528 A1
(43) Pub. Date: Jan. 23, 2025

(54) BOLT FASTENING STRUCTURE USING HOLE GUARD

(71) Applicant: GNI. Co.,Ltd., Hwaseong-si (KR)

(72) Inventor: Chang Su LIM, Hwaseong-si (KR)

(21) Appl. No.: 18/757,287

(22) Filed: Jun. 27, 2024

(30) Foreign Application Priority Data
Jul. 21, 2023 (KR) 10-2023-0095122
Jun. 4, 2024 (KR) 10-2024-0073166

(51) Int. Cl. F16B 41/00; F16B 43/00

(52) U.S. Cl. CPC F16B 41/002; F16B 43/00

(57) ABSTRACT

Disclosed is a bolt fastening structure using a hole guard that can be mounted on holes of various sizes. Since the bolt is fastened to the hole guard already mounted on a lower structure, it is possible to fasten the bolt to a steel pad having large holes or elongated holes or a grating plate where the holes have been damaged and the sizes of the holes are inconsistent. Moreover, by forming a locking groove, into which a lower horizontal part of the bolt is inserted, or a protruding groove and a protrusion for rotation and fixation of the lower horizontal part on the lower surface of the hole guard, both the fixed and pivoting types of the lower horizontal part can be secured upright to the hole guard.

### CROSS-REFERENCE TO RELATED PATENT APPLICATION

This application claims the benefit of Korean Patent Application No. 10-2023-0095122, filed on Jul. 21, 2023, No. 10-2024-0073166, filed on Jun. 4, 2024 in the Korean Intellectual Property Office, the disclosure of which is incorporated herein in its entirety by reference.

### BACKGROUND OF THE INVENTION

### 1. Field of the Invention

The present invention relates to a bolt fastening structure, and more specifically, to a bolt fastening structure using a hole guard that can be mounted on holes of various sizes.

### 2. Description of the Related Art

Generally, in production facilities, the equipment is securely installed on a lower structure such as a grating plate. Typically, the grating plate is installed at a certain height above the ground, and piping, wiring, etc. are placed below the grating plate to form such a shelf-like structure, a plurality of grating plates are placed at specified heights, typically ranging from approximately 4 m to 10 m. Production equipment is securely installed on these grating plates. The installation of the equipment is achieved in a conventional manner by fastening the equipment to the grating plates using brackets. However, it is difficult to secure the equipment to the grating plates using brackets without changing the position of the grating plates on which the equipment is placed. As mentioned above, since the grating plates are installed at specific heights in a shelf-like structure, another worker must manually assist in tightening fasteners such as bolts and nuts underneath the grating plates. This process is time-consuming and poses a risk to the worker underneath the grating plates.

Furthermore, serious safety accidents such as workers falling have occurred when lifting some of the grating plates installed in a shelf-like structure at production sites.

In addition, if the holes in the grating plates where the bolts are fastened become damaged and their sizes become irregular, or if the damaged holes prevent the use of fasteners such as bolts and nuts, there arises a problem where the grating plate itself must be replaced.

Meanwhile, in addition to the grating plates with holes formed therein, various types of support plates, such as grating plates with grid-shaped holes formed therein, flat steel pads, etc., are also used on the floor of the production site. The grid-shaped holes formed in these grating plates or the holes formed in the steel pads are not uniform in size, are larger in size than the holes formed in typical grating plates, or have a grid shape or elongated hole shape. Therefore, since it is impossible to use standard bolts to fit various hole sizes individually, a bolt fastening structure is required that can be fastened to fit each hole's specific size.

### REFERENCES OF THE RELATED ART

### Patent Document

Korean Patent No.: 10-0730721

### SUMMARY OF THE INVENTION

The present invention has been made in an effort to solve the above-described problems associated with prior art, and an object of the present invention is to provide a bolt fastening structure using a hole guard, which can quickly and firmly secure the equipment without changing a lower structure such as a grating plate or steel pad with holes of various sizes.

To achieve the above-mentioned object, the present invention provides a bolt fastening structure using a hole guard, comprising: a lower structure which is located below the equipment of an industrial facility and has holes for fastening; a hole guard which is inserted and secured into the hole of the lower structure; a T-bolt comprising an upper vertical part which has threads formed thereon and a lower horizontal part which is formed to have a predetermined length on both sides around the upper vertical part, the T-bolt being inserted and fastened into the hole guard; and a ring-shaped anti-falling washer which is fastened to the T-bolt and supported on the hole guard to prevent the T-bolt from falling below the lower structure.

The hole guard may comprise a support part which is disposed on the lower structure, a hole insertion part which is disposed below the support part and inserted into the hole of the lower structure, and a bolt hole which is formed through the support part and the hole insertion part to allow the insertion of the T-bolt.

The hole insertion part may have an outer diameter that is the same as the inner diameter of the hole formed in the lower structure.

The lower surface of the hole insertion part may comprise a locking groove to allow the T-bolt inserted into the hole guard to be secured to the hole guard.

The locking groove may be formed on both sides of the lower surface of the hole insertion part around the bolt hole.

The locking groove may have a width greater than the thickness of the lower horizontal part.

The bolt hole may have an elongated hole shape such that the lower horizontal part passes through the hole insertion part when the lower horizontal part of the T-bolt is inserted into the hole guard.

One side of the lower surface of the hole insertion part may comprise a protrusion to allow the T-bolt inserted into the hole guard to be secured to the hole guard.

The lower side of the hole insertion part may comprise a protruding groove to allow the lower horizontal part inserted into the hole insertion part to protrude from the side of the hole insertion part.

The lower horizontal part may be formed integrally with the upper vertical part and may have the same length on both sides around the upper vertical part.

The lower horizontal part may be formed integrally with the upper vertical part and may have different lengths from each other around the upper vertical part.

Both sides of the lower horizontal part may have a protruding part a protruding part of which one or both sides protrude from the hole insertion part around the upper vertical part so that the lower horizontal part is in contact with the lower structure.

The lower horizontal part may be connected to the bottom of the upper vertical part by means of a pivot pin so that the lower horizontal part is pivoted at the bottom of the upper vertical part.

The upper vertical part may comprise a pivot groove to allow the lower horizontal part to be inserted into the upper vertical part when the lower horizontal part is pivoted.

The lower horizontal part may be connected to the upper vertical part by the pivot pin so that one side of the lower horizontal part has a shorter length than the other side around the pivot pin.

The end of one side of the lower horizontal part may comprise a round part that is sloped from the top to the bottom.

The pivot groove may have a depth shorter than the lengths of both sides of the lower horizontal part.

The lower horizontal part may have an inserted state where the lower horizontal part is inserted into the pivot groove to allow the T-bolt to be inserted to the hole guard and a fixed state where after the T-bolt is inserted into the hole guard, the lower horizontal part is pivoted perpendicular to the upper vertical part to allow the T-bolt to be secured to the hole guard.

To achieve the above-mentioned object, the present invention provides a bolt fastening structure using the hole guard comprising: a lower structure which is located below the equipment of an industrial facility and has holes for fastening; a hole guard which has an outer diameter that is the same as the inner diameter of the hole formed in the lower structure and is inserted and secured into the hole of the lower structure; an L-bolt comprising an upper vertical part which has threads formed thereon and a lower horizontal part which is formed to extend to the bottom of the upper horizontal part through a bent part; and a ring-shaped anti-falling washer which is fastened to the L-bolt and supported on the hole guard to prevent the L-bolt from falling below the lower structure, wherein the hole guard comprises: a support part which is disposed on the lower structure; a hole insertion part which is disposed below the support part and inserted into the hole of the lower structure; and a bolt hole which is formed through the support part and the hole insertion part to allow the insertion of the L-bolt.

One side of the lower surface of the hole insertion part may comprise a protrusion to allow the L-bolt inserted into the hole guard to be secured to the hole guard.

According to the present invention, since the bolt is fastened to the hole guard 100 already mounted on the lower structure S, it is possible to fasten the bolt to a steel pad having large holes or elongated holes or a grating plate where the holes have been damaged and the sizes of the holes are inconsistent.

Moreover, by forming the locking groove, into which the lower horizontal part of the bolt is inserted, or the protruding groove and the protrusion for rotation and fixation of the lower horizontal part on the lower surface of the hole guard, both the fixed and pivoting types of the lower horizontal part can be secured upright to the hole guard.

Furthermore, since the installation of bolt is possible in one direction for holes of various sizes using the hole guard and the T-bolt or L-bolt, the bolt fastening structure using the hole guard according to the present invention can be widely used not only on the floor areas of industrial sites but also on H-beam structures at construction sites, as well as for hook hangers on ceilings or wall structures.

The technical effects of the present invention are not limited to those mentioned above, and other technical effects not mentioned will be clearly understood by those skilled in the art from the description below.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a bolt fastening structure using a hole guard of the present invention;

FIG. 2 is a cross-sectional view illustrating the bolt fastening structure using the hole guard of the present invention;

FIG. 3 is a diagram illustrating a hole guard according to a first embodiment of the present invention;

FIG. 4 is a diagram illustrating a hole guard according to a second embodiment of the present invention;

FIG. 5 is a diagram illustrating a T-bolt according to the first embodiment of the present invention;

FIG. 6 is a diagram illustrating the state where the T-bolt of the present invention is fastened to the lower structure using the hole guard;

FIG. 7 is a diagram illustrating a T-bolt according to the second embodiment of the present invention;

FIGS. 8A, 8B, 8C and 8D are diagrams illustrating another form of the T-bolt shown in FIGS. 5 and 7;

FIG. 9 is a diagram illustrating a T-bolt according to a third embodiment of the present invention;

FIG. 10 is a diagram illustrating a T-bolt according to a fourth embodiment of the present invention;

FIGS. 11A and 11B are diagrams illustrating another form of the T-bolt shown in FIGS. 9 and 10;

FIGS. 12 to 15 are diagrams illustrating a method of mounting the bolt fastening structure using the hole guard of the present invention;

FIG. 16 is a perspective view illustrating another embodiment of the bolt fastening structure using the hole guard of the present invention;

FIG. 17 is a diagram illustrating another embodiment of the bolt fastening structure using the hole guard of the present invention;

FIG. 18 is a diagram illustrating a hole guard according to the third embodiment of the present invention;

FIG. 19 is a diagram illustrating a T-bolt according to a fifth embodiment of the present invention;

FIG. 20 is a diagram illustrating the fixed state of the T-bolt according to the fifth embodiment of the present invention;

FIG. 21 is a diagram illustrating the inserted state of the T-bolt according to the fifth embodiment of the present invention;

FIG. 22 is a diagram illustrating a method of coupling the hole guard according to the third embodiment of the present invention and the T-bolt according to the fifth embodiment;

FIG. 23 is a perspective view illustrating another embodiment of the bolt fastening structure using the hole guard of the present invention;

FIG. 24 is a diagram illustrating another embodiment of the bolt fastening structure using the hole guard of the present invention;

FIG. 25 is a diagram illustrating a hole guard according to the fourth embodiment of the present invention;

FIG. 26 is a diagram illustrating a method of coupling the T-bolt using the hole guard according to the fourth embodiment of the present invention;

FIG. 27 is a perspective view illustrating another embodiment of the bolt fastening structure using the hole guard of the present invention;

FIG. 28 is a diagram illustrating another embodiment of the bolt fastening structure using the hole guard of the present invention;

FIG. 29 is a diagram illustrating an L-bolt of the present invention; and

FIGS. 30 to 33 are diagrams illustrating a method of mounting the bolt fastening structure using the hole guard according to the third embodiment of the present invention and the T-bolt according to the fifth embodiment of the present invention.

### DETAILED DESCRIPTION OF THE INVENTION

As the present invention allows for various changes and numerous embodiments, particular embodiments will be illustrated in the drawings and described in detail in the written description. However, this is not intended to limit the present invention to particular embodiments, and it is to be appreciated that all changes, equivalents, and substitutes that do not depart from the spirit and technical scope of the present invention are encompassed in the present invention. In the following description of the present invention, if it is determined that a detailed description of relevant prior art may obscure the gist of the present invention, the detailed descriptions will be omitted.

Hereinafter, exemplary embodiments according to the present invention will be described in detail with reference to the accompanying drawings. In the following description with reference to the accompanying drawings, identical or corresponding components will be assigned the same reference numerals, and redundant description thereof will be omitted.

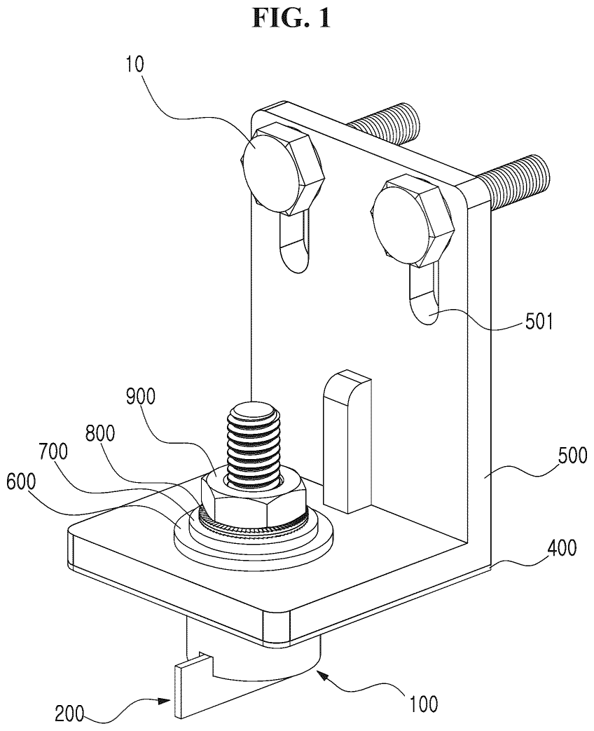

FIG. 1 is a diagram illustrating a bolt fastening structure using a hole guard of the present invention.

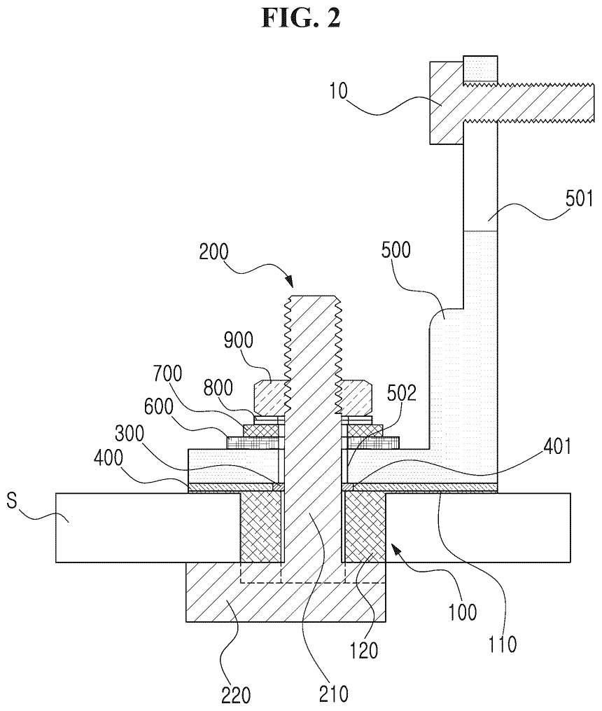

FIG. 2 is a cross-sectional view illustrating the bolt fastening structure using the hole guard of the present invention.

Referring to FIGS. 1 and 2, the bolt fastening structure using the hole guard of the present invention may comprise a hole guard 100, a T-bolt 200, an anti-falling washer 300, a buffer pad 400, a bracket 500, a flat washer 600, a coupling washer 700, an anti-loosening washer 800, and a fixing nut 900.

First, the hole guard 100 may be mounted on a lower structure of an industrial facility, which has holes formed on the floor for fastening. More specifically, the hole guard 100 can be mounted on, for example, a steel pad S having large holes or elongated holes or a grating plate G where the holes have been damaged and the sizes of the holes are inconsistent, on which the equipment cannot be mounted using only the T-bolt 200. In other words, the equipment can be secured to the holes of a typical steel pad S or grating plate G using only the T-bolts 200; however, for a steel pad S having large holes or elongated holes or a grating plate G where the holes have been damaged and the sizes of the holes are inconsistent, the T-bolt 200 can be mounted on the lower structure S using the hole guard 100.

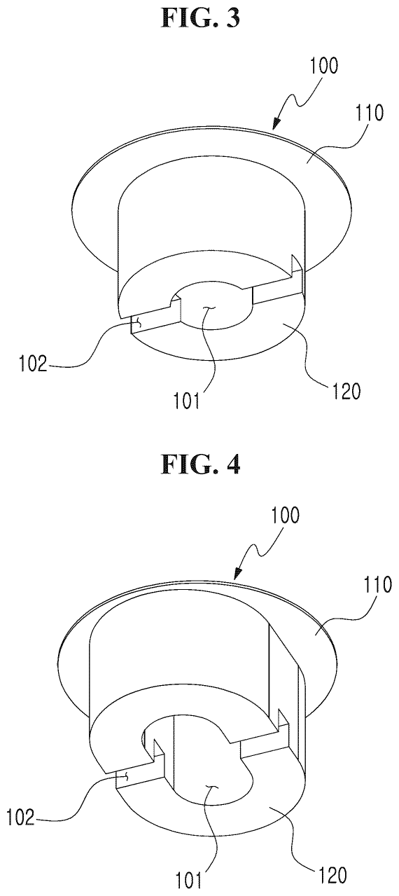

FIG. 3 is a diagram illustrating a hole guard according to a first embodiment of the present invention.

Referring to FIG. 3, the hole guard 100 according to the first embodiment of the present invention may comprise a plate-shaped support part 110 and a hole insertion part 120 disposed below the support part 110. For example, the support part 110 and the hole insertion part 120 may be integrally formed. A bolt hole 101 may be formed through the support part 110 and the hole insertion part 120 to allow the insertion and mounting of the T-bolt 200.

The support part 110 may have a plate shape, which may be either rectangular or circular, and it may be larger than the size of the hole formed in the lower structure S. In other words, the support part 110 may be the portion that is supported on the upper surface of the lower structure S.

The hole insertion part 120 may be disposed below the support part 110 and inserted into the hole of the lower structure S. The hole insertion part 120 may have a cylindrical shape with a predetermined height. In this case, the hole insertion part 120 may have the same shape and size as the hole formed in the lower structure S. For example, if the hole in the lower structure S has a large circular shape or if the hole has been damaged and expanded, the hole insertion part 120 may be adjusted to the size of the hole formed in the lower structure S or the size of the expanded hole. Depending on the equipment to be secured on the lower structure S, one or more of these hole insertion parts 120 may be disposed below the support part 110.

When the hole insertion part 120 is inserted into the hole of the lower structure S, the hole guard 100 can be supported on the upper surface of the lower structure S by means of the support part 110, making it possible to prevent the hole guard 100 from falling below the lower structure S.

Moreover, if the hole insertion part 120 has a cylindrical shape with a predetermined height, it is desirable for the bolt hole 101 formed in the hole guard 100 to have an elongated hole shape. This is intended to ensure that when the T-bolt 200 is inserted into the bolt hole 101 of the hole guard 100, a lower horizontal part 220 of the T-bolt 200 can pass through the hole insertion part 120 having a predetermined height. For example, according to the bolt fastening structure of the present invention, when the T-bolt 200 is inserted into the bolt hole 101 of the hole guard 100, it is installed and mounted starting from the lower horizontal part 220 of the T-bolt 200. Therefore, the bolt hole 101 must have an elongated hole shape to allow the T-bolt 200 to pass through the bolt hole 101 without any interference with the lower horizontal part 220 of the T-bolt 200.

The lower portion of the hole insertion part 120 may comprise a locking groove 102 to secure the T-bolt 200. For example, the locking groove 102 may be formed on both sides of the lower surface of the hole insertion part 120 around the bolt hole 101. In this case, the locking groove 102 may have a width greater than the thickness of the lower horizontal part 220 of the T-bolt 200. Moreover, the locking groove 102 may have a predetermined depth such that when the lower horizontal part 220 of the T-bolt 200 is inserted into the locking groove 102, the T-bolt 200 is fixed and prevented from rotating. In other words, the locking groove 102 allows the T-bolt 200 mounted on the hole guard 100 to be secured to the hole guard 100. Furthermore, the locking groove 102 allows the T-bolt 200 to be secured in an upright position within the hole guard 100. Therefore, the worker can quickly and securely fasten the fixing nut 900 to the T-bolt 200 even from the top of the lower structure S.

Additionally, the locking groove 102 may function to prevent the secured T-bolt 200 from loosening due to vibration or impact. For example, the T-bolt 200 secured to the hole guard 100 may be loosened if the vibration or impact generated from the equipment is transmitted to the lower structure S. However, the T-bolt 200 according to the present invention can be prevented from rotating by the locking groove 102, making it possible to prevent the T-bolt 200 from loosening due to the vibration or impact. For example, even when the fixing nut 900 is to be released, the lower horizontal part 220 can be secured by the locking groove 102, allowing the worker to quickly and securely release the fixing nut 900 from the top of the lower structure S without separately securing the T-bolt 200.

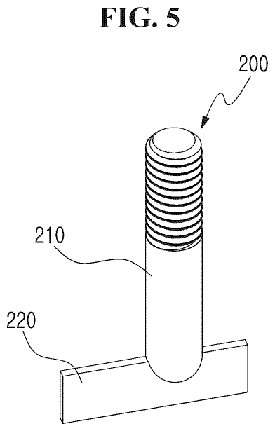

FIG. 4 is a diagram illustrating a hole guard according to a second embodiment of the present invention.

Referring to FIG. 4, the hole guard 100 according to the second embodiment may comprise a plate-shaped support part 110 and a hole insertion part 120 disposed below the support part 110, similarly to the first embodiment. Moreover, a bolt hole 101 may be formed through the support part 110 and the hole insertion part 120 to allow the insertion and mounting of the T-bolt 200. However, the hole insertion part 120 of the hole guard 100 according to the second embodiment may have an oval shape.

For example, if the hole of the lower structure S has a large elongated hole shape or if the hole is damaged into an elongated hole shape, it may be difficult to secure the hole guard 100 in a desired position because the circular hole insertion part 120 can rotate within the elongated hole of the lower structure S and move along the elongated hole. However, the hole guard 100 according to the second embodiment can prevent the hole insertion part 120 from rotating within the elongated hole of the lower structure S because the hole insertion part 120 has an oval shape. Therefore, even if the hole of the lower structure S has an elongated hole shape, the worker can quickly and securely fasten the fixing nut 900 to the T-bolt 200.

As described above, the bolt fastening structure according to the present invention allows the T-bolt 200 to be safely and easily mounted on the lower structure S by means of the hole guard 100 in the case where the lower structure S is a steel pad having large holes or elongated holes or a grating plate where the holes are damaged or the sizes of the holes are inconsistent.

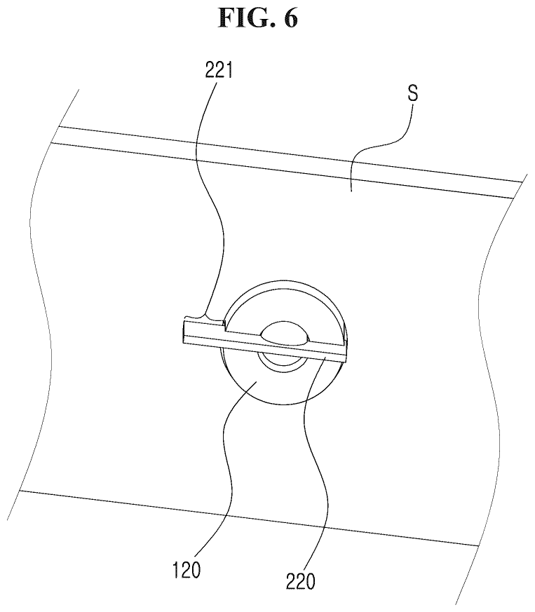

FIG. 5 is a diagram illustrating a T-bolt according to the first embodiment of the present invention.

Referring to FIG. 5, the T-bolt 200 according to the first embodiment of the present invention may have an inverted “T” shape and comprise an upper vertical part 210 and a lower horizontal part 220. The lower horizontal part 220 may be disposed below the upper vertical part 210 and may be formed integrally with the upper vertical part 210.

The upper vertical part 210 is the portion that penetrates the lower structure S, the bracket 500 placed thereon, and a fastening hole provided by fastening elements, and has a threaded groove, onto which the fixing nut 900 is secured. That is, the upper vertical part 210 may be the portion that is exposed above the hole guard 100 when the T-bolt 200 is mounted on the hole guard 100. Therefore, by fastening the fixing nut 900 to the exposed upper vertical part 210, the bracket 500 can be secured to the lower structure S.

The lower horizontal part 220 may be the portion that is inserted into the bolt hole 101 of the hole guard 100 and located below the lower structure S to be pressed against the lower surface of the hole guard 100 when the T-bolt 200 is mounted on the hole guard 100. That is, the lower horizontal part 220 can be inserted into the locking groove 102 of the hole guard 100, thus allowing the T-bolt 200 to be secured upright within the hole guard 100.

Moreover, the lower horizontal part 220 may be configured to protrude from both sides around the upper vertical part 210 so that it can be inserted into the locking groove 102 of the hole guard 100. In this case, the protruding sides of the lower horizontal part 220 may have different lengths from each other around the upper vertical part 210. For example, the length of one side of the lower horizontal part 220 may be long enough to be inserted into the locking groove 102 of the hole guard 100, while the length of the other side of the lower horizontal part 220 may be long enough to protrude from the hole insertion part 120 of the hole guard 100.

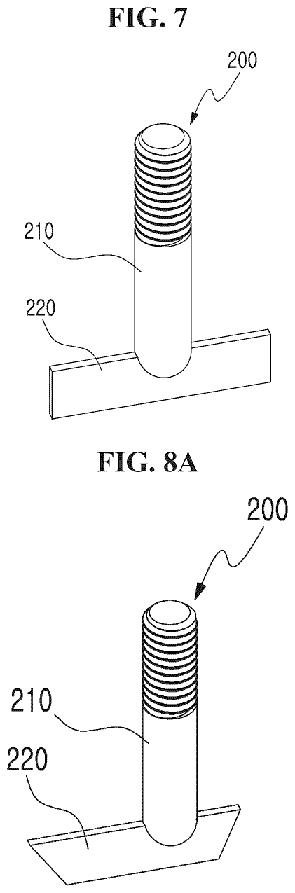

FIG. 6 is a diagram illustrating the state where the T-bolt of the present invention is fastened to the lower structure using the hole guard.

Referring to FIG. 6, one side of the lower horizontal part 220 is positioned within the hole insertion part 120 of the hole guard 100, while the other side, which is longer than the former, has a protruding part 221 that is in contact with the lower surface of the lower structure S. This is intended to ensure that the hole guard 100 is firmly secured to the lower structure S by means of the T-bolt 200. For example, when the fixing nut 900 is fastened with the hole guard 100 and the T-bolt 200 inserted into the lower structure S, the protruding part 221 of the lower horizontal part 220 supports the lower surface of the lower structure S, and as a result, the hole guard 100 can be firmly secured between the lower horizontal part 220 and the fixing nut 900 through compression.

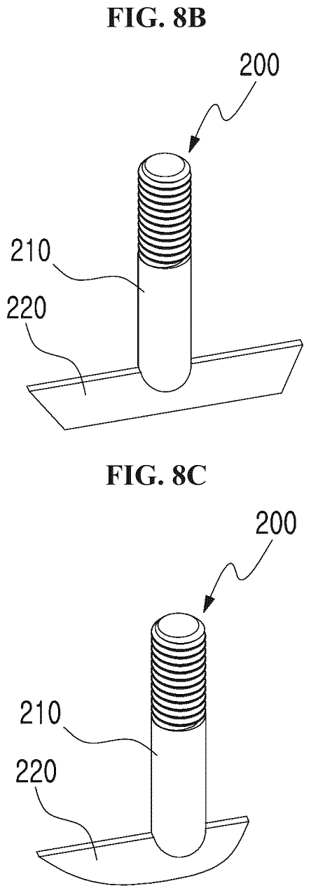

FIG. 7 is a diagram illustrating a T-bolt according to the second embodiment of the present invention.

Referring to FIG. 7, the T-bolt 200 according to the second embodiment of the present invention may comprise an upper vertical part 210 and a lower horizontal part 220. In this case, the lower horizontal part 220 is also disposed below the upper vertical part 210 and may be formed integrally with the upper vertical part 210.

However, the lower horizontal part 220 of the T-bolt 200 according to the second embodiment may be configured to protrude from both sides around the upper vertical part 210 so that it can be inserted into the locking groove 102 of the hole guard 100, but both sides of the lower horizontal part 220 may have the same length.

For example, both sides of the lower horizontal part 220 around the upper vertical part 210 may be long enough to protrude from the hole insertion part 120 of the hole guard 100. In other words, both sides of the lower horizontal part 220 may have a protruding part 221 protruding from the hole insertion part 120. Therefore, the protruding parts 221 on both sides of the lower horizontal part 220 can support the lower structure S from both sides, allowing the hole guard 100 to be more firmly secured to the lower structure S while maintaining the T-bolt 200 upright when the fixing nut 900 is fastened. However, since the lower horizontal part 220 of the second embodiment is greater than the length of the lower horizontal part 220 of the first embodiment, the T-bolt 200 must be inserted and fastened into the hole guard 100 from the bottom to the top.

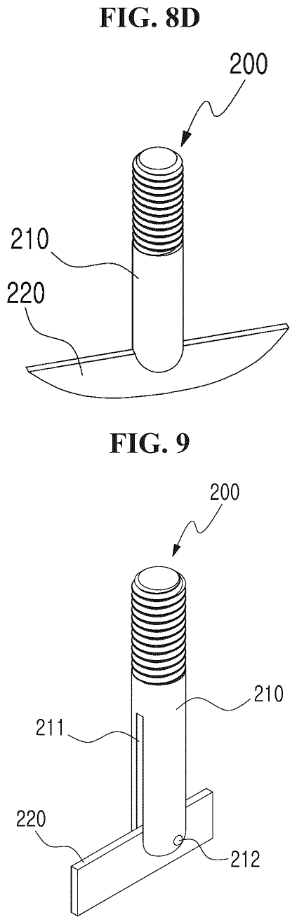

FIGS. 8A, 8B, 8C and 8D are diagrams illustrating another form of the T-bolt shown in FIGS. 5 and 7.

Here, FIGS. 8A and 8B respectively illustrate that the lower horizontal parts 220 of the T-bolt 200 according to the first embodiment and the T-bolt 200 according to the second embodiment have a sloped shape at both ends, and FIGS. 8C and 8D respectively illustrate that the lower horizontal parts 220 of the T-bolt 200 according to the first embodiment and the T-bolt 200 according to the second embodiment have a round shape at the bottom.

First, referring to FIGS. 8A and 8B, the lower horizontal part 220 of the T-bolt 200 has a sloped shape at both ends, with the lower length of the lower horizontal part 220 being shorter than the upper length. In other words, by removing the lower corner areas of at both ends of the lower horizontal part 220, it is possible to allow the lower horizontal part 220 to pass smoothly through the bolt hole 101 when the T-bolt 200 is inserted into the hole guard 100. Moreover, as shown in FIGS. 8C and 8D, by forming the lower surface of the lower horizontal part 220 into a round shape, it is possible to allow the lower horizontal part 220 to pass more smoothly through the bolt hole 101.

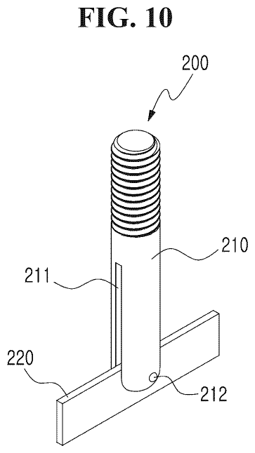

FIG. 9 is a diagram illustrating a T-bolt according to a third embodiment of the present invention.

Referring to FIG. 9, the T-bolt 200 according to the third embodiment of the present invention may have an inverted “T” shape and comprise an upper vertical part 210 and a lower horizontal part 220. The lower horizontal part 220 may be disposed below the upper vertical part 210 and may be pivotably connected to the upper vertical part 210.

The upper vertical part 210 is the portion that penetrates the lower structure S, the bracket 500 placed thereon, and a fastening hole provided by fastening elements, and has a threaded groove, onto which the fixing nut 900 is secured. That is, the upper vertical part 210 may be the portion that is exposed above the hole guard 100 when the T-bolt 200 is mounted on the hole guard 100. Therefore, by fastening the fixing nut 900 to the exposed upper vertical part 210, the bracket 500 can be secured to the lower structure S. Moreover, the upper vertical part 210 may comprise a pivot groove 211 to allow the lower horizontal part 220 to be inserted into the upper vertical part 210 by the pivoting of the lower horizontal part 220.

The lower horizontal part 220 may be the portion that is inserted into the bolt hole 101 of the hole guard 100 and located below the lower structure S to be pressed against the lower surface of the hole guard 100 when the T-bolt 200 is mounted on the hole guard 100. That is, the lower horizontal part 220 can be inserted into the locking groove 102 of the hole guard 100, thus allowing the T-bolt 200 to be secured upright within the hole guard 100.

Furthermore, the lower horizontal part 220 may be connected to the bottom of the upper vertical part 210 by means of a pivot pin 212 so that the lower horizontal part 220 can be pivoted at the bottom of the upper vertical part 210. In other words, the lower horizontal part 220 can pivot in a circular motion around the pivot pin 212 at the bottom of the upper vertical part 210. For example, the lower horizontal part 220 may have an inserted state where it is pivoted around the pivot pin 212 and inserted into the pivot groove 211 of the upper vertical part 210 and a fixed state where it is pivoted perpendicular to the upper vertical part 210.

More specifically, when the lower horizontal part 220 is in the inserted state, the T-bolt 200 according to the third embodiment may be inserted into the bolt hole 101 of the hole guard 100. After the T-bolt 200 is inserted into the hole guard 100 and when the lower horizontal part 220 is in the fixed state where it is pivoted perpendicular to the upper vertical part 210, the lower horizontal part 220 can be fastened to the locking groove 102 of the hole guard 100, allowing the T-bolt 200 to be secured to the hole guard 100.

For example, the worker inserts the lower horizontal part 220 into the pivot groove 211 to be in the inserted state, and then inserts the T-bolt 200 into the hole guard 100. In a state where the T-bolt 200 is inserted into the hole guard 100, the worker gently shakes the T-bolt 200 so that the lower horizontal part 220 is pivoted. When the lower horizontal part 220 is in the fixed state due to the pivoting of the lower horizontal part 220, the T-bolt 200 may be moved upward so that the lower horizontal part 220 is fastened to the locking groove 102 of the hole guard 100, allowing the T-bolt 200 to be secured to the hole guard 100.

In this case, the protruding sides of the lower horizontal part 220 may have different lengths from each other around the upper vertical part 210. For example, the length of one side of the lower horizontal part 220 may be long enough to be inserted into the locking groove 102 of the hole guard 100, while the length of the other side of the lower horizontal part 220 may be long enough to protrude from the hole insertion part 120 of the hole guard 100.

In other words, when the lower horizontal part 220 is in the fixed state, one side of the lower horizontal part 220 is positioned within the hole insertion part 120 of the hole guard 100, while the other side, which is longer than the former, has a protruding part 221 that is in contact with the lower surface of the lower structure S. This is intended to ensure that the hole guard 100 is firmly secured to the lower structure S by means of the T-bolt 200, similarly to the first embodiment shown in FIG. 5.

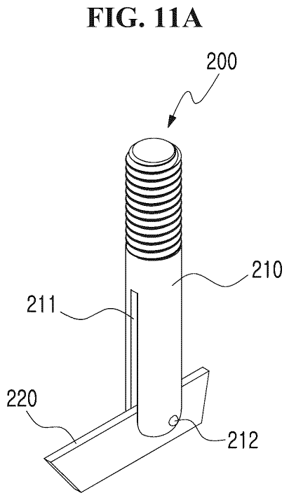

FIG. 10 is a diagram illustrating a T-bolt according to a fourth embodiment of the present invention.

Referring to FIG. 10, the T-bolt 200 according to the fourth embodiment of the present invention may comprise an upper vertical part 210 and a lower horizontal part 220. Also, the lower horizontal part 220 may be disposed below the upper vertical part 210 and may be pivotably connected to the upper vertical part 210.

However, the lower horizontal part 220 of the T-bolt 200 according to the fourth embodiment may be configured to protrude from both sides around the upper vertical part 210 so that it can be inserted into the locking groove 102 of the hole guard 100, but both sides of the lower horizontal part 220 may have the same length. For example, both sides of the lower horizontal part 220 around the upper vertical part 210 may be long enough to protrude from the hole insertion part 120 of the hole guard 100. In other words, both sides of the lower horizontal part 220 may have a protruding part 221 protruding from the hole insertion part 120. Therefore, similarly to the second embodiment shown in FIG. 7, the protruding parts 221 on both sides of the lower horizontal part 220 can support the lower structure S from both sides, allowing the hole guard 100 to be more firmly secured to the lower structure S while maintaining the T-bolt 200 upright when the fixing nut 900 is fastened.

Moreover, the T-bolt 200 according to the fourth embodiment has an inserted state where the lower horizontal part 220 is pivoted around the pivot pin 212 and inserted into the pivot groove 211, and thus although the lower horizontal part 220 of the fourth embodiment is greater than the length of the lower horizontal part 220 of the third embodiment, the T-bolt 200 can be inserted and fastened into the hole guard 100 from the top to the bottom.

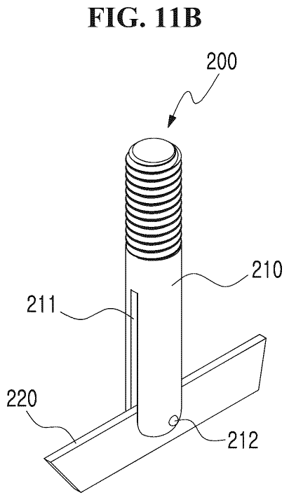

FIGS. 11A and 11B are diagrams illustrating another form of the T-bolt shown in FIGS. 9 and 10.

Here, FIGS. 11A and 11B respectively illustrate that lower horizontal part 220 of the T-bolt 200 according to the third embodiment and the T-bolt 200 according to the fourth embodiment have a sloped shape at both ends.

Referring to FIGS. 11A and 11B, the lower horizontal part 220 of the T-bolt 200 may have a sloped shape at both ends. In other words, by removing the lower corner areas of at both ends of the lower horizontal part 220 to allow both ends of the lower horizontal part 220 to have a sloped shape, it is possible to allow the T-bolt 200 to pass smoothly through the bolt hole 101 while the lower horizontal part 220 is inserted.

Still referring to FIGS. 1 and 2, the anti-falling washer 300 may be inserted into the T-bolt 200 and mounted on the upper vertical part 210. That is, the T-bolt 200 with the anti-falling washer 300 mounted thereon can be inserted into the bolt hole 101 of the hole guard 100, and then the anti-falling washer 300 can be arranged to be supported on the upper surface of the hole guard 100, making it possible to prevent the T-bolt 200 from falling below the lower structure S.

As can be seen from the drawings, the bracket 500 may have an “L” shape, but is not limited thereto. Various other forms can be applied where one side is coupled to the equipment and the other side can be coupled to the supporting part.

One side of the bracket 500 comprises one or more first coupling holes 501 for coupling to the equipment, and the other side comprises a second coupling hole 502. Coupling bolts 10 are fastened to threaded holes (not shown) of the equipment through the first coupling holes 501 of the bracket 500, and the T-bolt 200 is inserted into the second coupling hole 502. Therefore, the bracket 500 can be placed on the anti-falling washer 300.

In this case, a buffer pad 400 with a washer hole 401 may be provided between the bracket 500 and the lower structure S. The buffer pad 400 may be disposed on the hole guard 100 so that the anti-falling washer 300 is inserted into the washer hole 401. Therefore, the buffer pad 400 can prevent the vibration from the lower structure S from being transmitted upwards, and the anti-falling washer 300 can prevent the bracket 500 from being structurally lifted.

The flat washer 600, the coupling washer 700, and the anti-loosening washer 800 are sequentially disposed on the top the bracket 500, and the fixing nut 900 is fastened to the top of the anti-loosening washer 800. After fastening the fixing nut 900, a protruding part may be formed on the surface of the anti-loosening washer 800 to prevent the fixing nut 900 from loosening due to vibration or external shock.

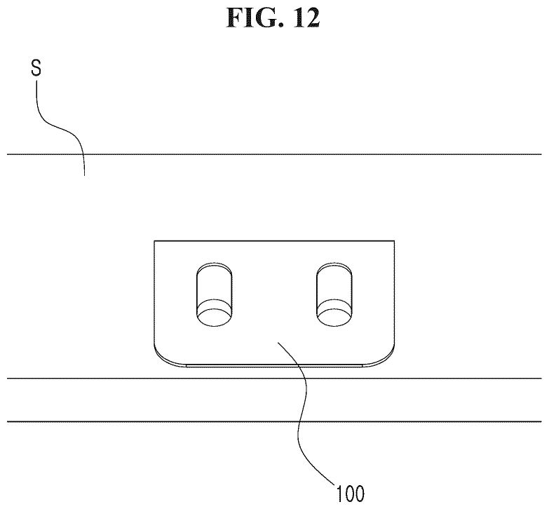

FIGS. 12 to 15 are diagrams illustrating a method of mounting a bolt fastening structure using the hole guard of the present invention.

Here, the hole guard 100 is exemplified as having two hole insertion parts 120 in one support part 110 for mounting to the bracket 500 having two second coupling holes 502.

First, referring to FIG. 12, the hole guard 100 is mounted on a lower structure S such as a steel pad having large holes or elongated holes. In this case, the hole insertion part 120 of the hole guard 100 may be selected to have the same size and shape as the hole of the lower structure S. The selected hole insertion part 120 is inserted and mounted into the hole of the lower structure S. At this time, depending on the equipment to be secured on the lower structure S, one or more of these hole insertion parts 120 may be disposed below the support part 110.

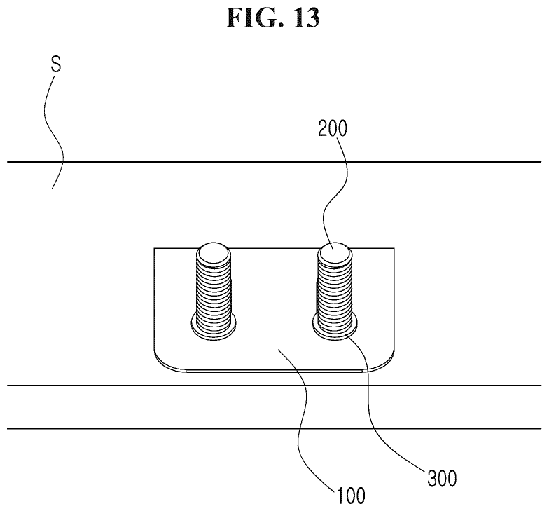

Referring to FIG. 13, the T-bolt 200 with the anti-falling washer 300 mounted thereon is fastened to the hole guard 100. The T-bolt 200 can be fastened by inserting the lower horizontal part 220 into the hole guard 100 on the top of the lower structure S and then allowing the inserted lower horizontal part 220 to be inserted into the locking groove 102 at the bottom of the hole guard 100. At this time, the T-bolt 200 can be secured by the anti-falling washer 300 to prevent the T-bolt 200 from falling below the lower structure S.

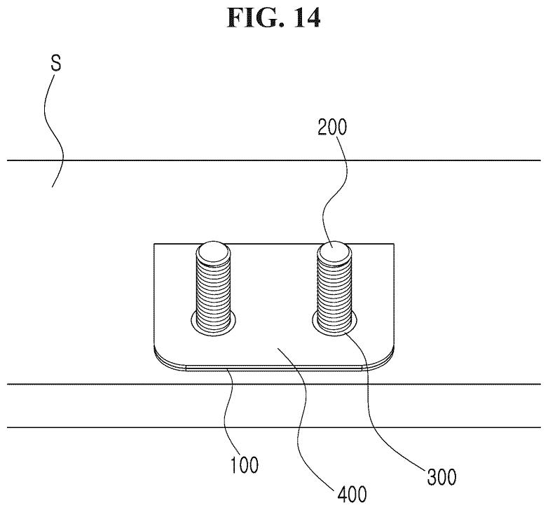

Referring to FIG. 14, the buffer pad 400 is mounted on the hole guard 100. The buffer pad 400 may be arranged to cover the entire upper surface of the hole guard 100, and the T-bolt 200 and the anti-falling washer 300 may be exposed to the outside by the washer hole 401 formed in the buffer pad 400. For example, it is desirable for the buffer pad 400 to be made of an elastic rubber material.

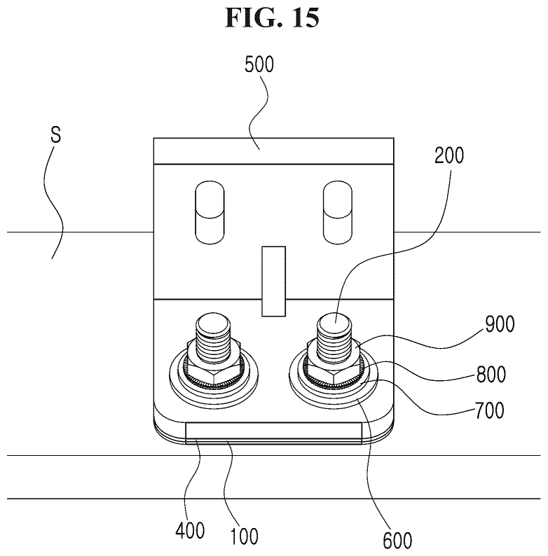

Referring to FIG. 15, the bracket 500 may be placed on the buffer pad 400. Moreover, the flat washer 600, the coupling washer 700, the anti-loosening washer 800, and the fixing nut 900 may be sequentially fastened to the T-bolt 200 exposed above the bracket 500. At this time, by means of the fastened fixing nut 900, the protruding part 221 of the lower horizontal part 220 supports the lower surface of the lower structure S and presses the hole guard 100, allowing the hole guard 100 fastened to the lower structure S to be more firmly secured thereto.

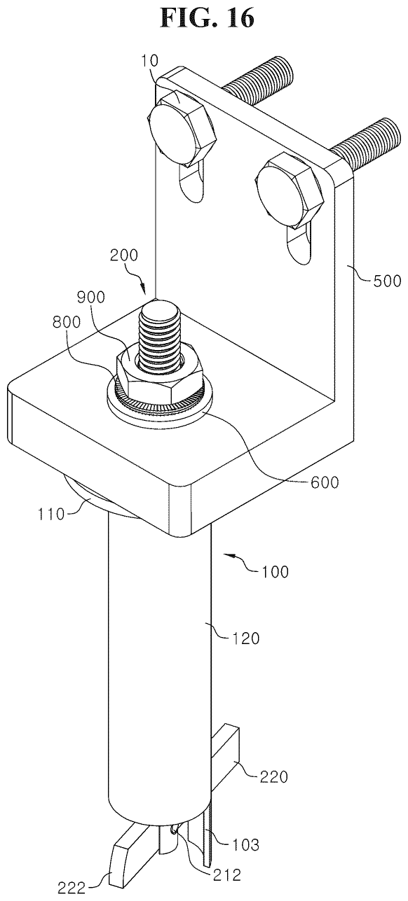

FIG. 16 is a perspective view illustrating another embodiment of the bolt fastening structure using the hole guard of the present invention.

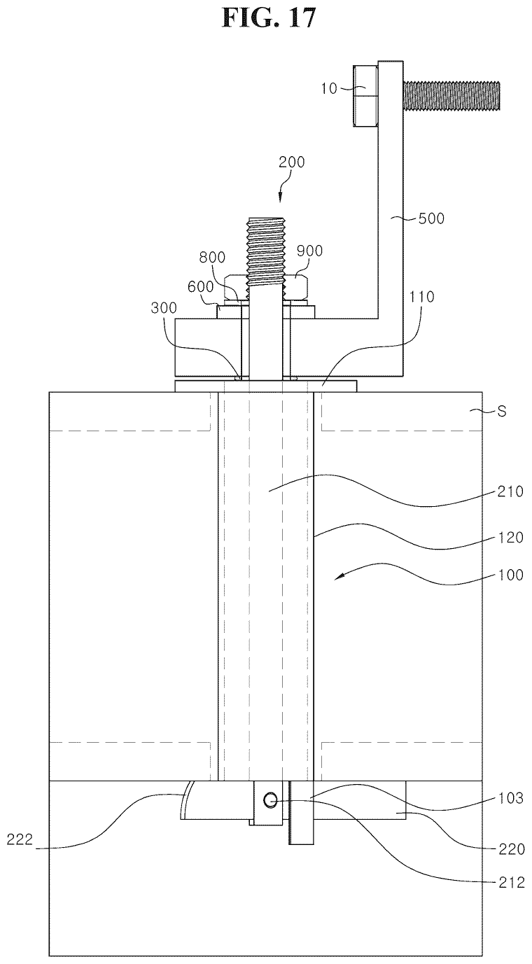

FIG. 17 is a diagram illustrating another embodiment of the bolt fastening structure using the hole guard of the present invention.

Referring to FIGS. 16 and 17, another embodiment of the bolt fastening structure using the hole guard of the present invention may comprise a hole guard 100, a T-bolt 200, an anti-falling washer 300, a bracket 500, a flat washer 600, an anti-loosening washer 800, and a fixing nut 900.

First, another embodiment of the bolt fastening structure using the hole guard 100 can be mounted on, for example, a steel pad or grating plate where the holes are deep or the hole are spaced apart and formed doubly, on which it cannot be mounted using only the T-bolt 200.

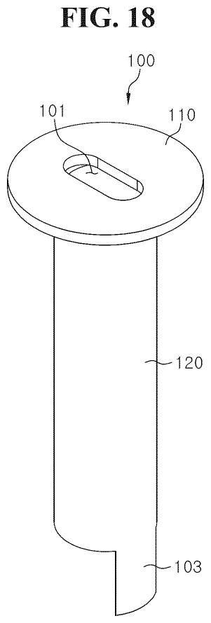

FIG. 18 is a diagram illustrating a hole guard according to the third embodiment of the present invention.

Referring to FIG. 18, the hole guard 100 according to the third embodiment of the present invention may comprise a plate-shaped support part 110 and a hole insertion part 120 disposed below the support part 110. For example, the support part 110 and the hole insertion part 120 may be integrally formed. A bolt hole 101 may be formed through the support part 110 and the hole insertion part 120 to allow the insertion and mounting of the T-bolt 200. The bolt hole 101 may extend from the support part 110 to the hole insertion part 120. In this case, the bolt hole 101 formed in the hole insertion part 120 may be shaped so that the hole insertion part 120 has an empty cylindrical shape, and the bolt hole 101 formed in the support part 110 may have an elongated hole shape to allow the T-bolt 200 to be easily inserted into the hole guard 100.

The support part 110 may have a plate shape, which may be either rectangular or circular, and it may be larger than the size of the hole formed in the lower structure S. In other words, the support part 110 may be the portion that is supported on the upper surface of the lower structure S.

The hole insertion part 120 may be disposed below the support part 110 and inserted into the hole of the lower structure S. The hole insertion part 120 may have a cylindrical shape with a predetermined height. For example, the hole insertion part 120 according to the third embodiment may be greater than the length of the hole insertion part 120 according to the first and second embodiments. This is intended to ensure that the bolt fastening structure using the hole guard 100 can be mounted on, for example, a lower structure S such as a steel pad or grating plate where the holes are deep or the hole are spaced apart and formed doubly, on which it cannot be mounted using only the short hole guard 100 and the T-bolt 200.

The hole insertion part 120 may have the same shape and size as the hole formed in the lower structure S. For example, if the hole in the lower structure S has a large circular shape or if the hole has been damaged and expanded, the hole insertion part 120 may be adjusted to the size of the hole formed in the lower structure S or the size of the expanded hole. Depending on the equipment to be secured on the lower structure S, one or more of these hole insertion parts 120 may be disposed below the support part 110.

When the hole insertion part 120 is inserted into the hole of the lower structure S, the hole guard 100 can be supported on the upper surface of the lower structure S by means of the support part 110, making it possible to prevent the hole guard 100 from falling below the lower structure S.

One side of the lower surface of the hole insertion part 120 may comprise a protrusion 103 that protrudes from the lower surface. The protrusion 103 may function to prevent the lower horizontal part 220 of the T-bolt 200 from rotating after the T-bolt 200 is inserted into the hole guard 100. For example, when the lower horizontal part 220 of the T-bolt 200 inserted into the hole guard 100 is rotated around the pivot pin 212 so that it is perpendicular to the upper vertical part 210, the lower horizontal part 220 may be securely engaged with the protrusion 103. In other words, the protrusion 103 allows the T-bolt 200 mounted on the hole guard 100 to be secured in place. Therefore, the worker can quickly and securely fasten the fixing nut 900 to the T-bolt 200 even from the top of the lower structure S.

Additionally, the protrusion 103 may function to prevent the secured T-bolt 200 from loosening due to vibration or impact. For example, the T-bolt 200 secured to the hole guard 100 may be loosened if the vibration or impact generated from the equipment is transmitted to the lower structure S. However, the T-bolt 200 according to the present invention can be prevented from rotating by the protrusion 103, making it possible to prevent the T-bolt 200 from loosening due to the vibration or impact. For example, even when the fixing nut 900 is to be released, the lower horizontal part 220 can be secured by the protrusion 103, allowing the worker to quickly and securely release the fixing nut 900 from the top of the lower structure S without separately securing the T-bolt 200.

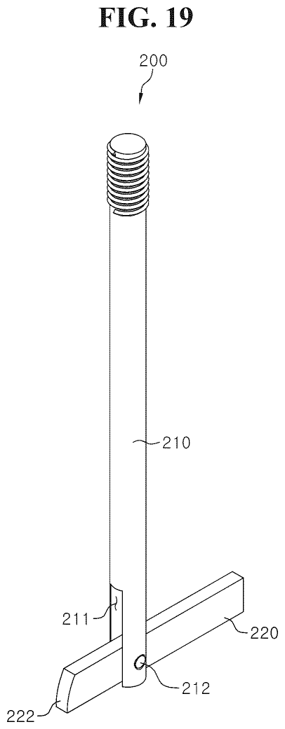

FIG. 19 is a diagram illustrating a T-bolt according to a fifth embodiment of the present invention.

Referring to FIG. 19, the T-bolt 200 according to the fifth embodiment of the present invention may have an inverted “T” shape and comprise an upper vertical part 210 and a lower horizontal part 220. The lower horizontal part 220 may be disposed below the upper vertical part 210 and may be pivotably connected to the upper vertical part 210 by means of a pivot pin 212.

The upper vertical part 210 is the portion that penetrates the lower structure S, the bracket 500 placed thereon, and a fastening hole provided by fastening elements, and has a threaded groove, onto which the fixing nut 900 is secured. That is, the upper vertical part 210 may be the portion that is exposed above the hole guard 100 when the T-bolt 200 is mounted on the hole guard 100. Therefore, by fastening the fixing nut 900 to the exposed upper vertical part 210, the bracket 500 can be secured to the lower structure S. Moreover, the upper vertical part 210 may comprise a pivot groove 211 to allow the lower horizontal part 220 to be inserted into the upper vertical part 210 by the pivoting of the lower horizontal part 220. In this case, it is desirable for the pivot groove 211 to be shorter than the length of the lower horizontal parts 220 positioned on both sides of the pivot pin 212.

The lower horizontal part 220 may be the portion that is inserted into the bolt hole 101 of the hole guard 100 and located below the lower structure S to be pressed against the lower surface of the lower structure S when the T-bolt 200 is mounted on the hole guard 100. That is, the lower horizontal part 220 can be engaged with the protrusion 103 of the hole guard 100, thus allowing the T-bolt 200 to be secured upright within the hole guard 100.

Furthermore, the lower horizontal part 220 may be connected to the bottom of the upper vertical part 210 by means of a pivot pin 212 so that the lower horizontal part 220 can be pivoted at the bottom of the upper vertical part 210. In other words, the lower horizontal part 220 can pivot in a circular motion around the pivot pin 212 at the bottom of the upper vertical part 210. For example, the lower horizontal part 220 may have an inserted state where it is pivoted around the pivot pin 212 and inserted into the pivot groove 211 of the upper vertical part 210 and a fixed state where it is pivoted perpendicular to the upper vertical part 210.

More specifically, when the lower horizontal part 220 is in the inserted state, the T-bolt 200 can be inserted into the bolt hole 101 of the hole guard 100. After the T-bolt 200 is inserted into the hole guard 100 and when the lower horizontal part 220 is in the fixed state where it is pivoted perpendicular to the upper vertical part 210, the lower horizontal part 220 can be engaged with the protrusion 103 of the hole guard 100, allowing the T-bolt 200 to be secured to the hole guard 100.

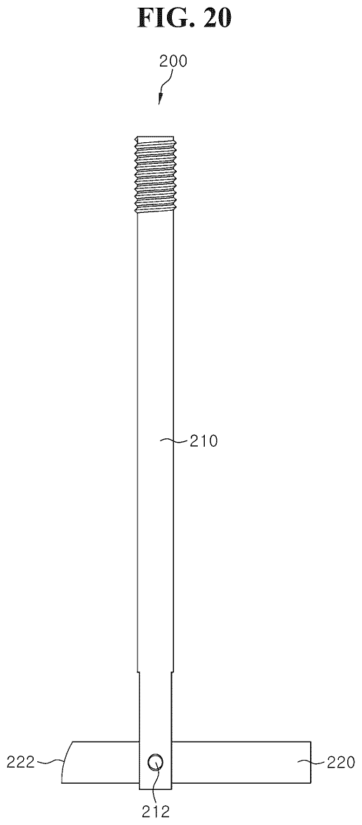

FIG. 20 is a diagram illustrating the fixed state of the T-bolt according to the fifth embodiment of the present invention.

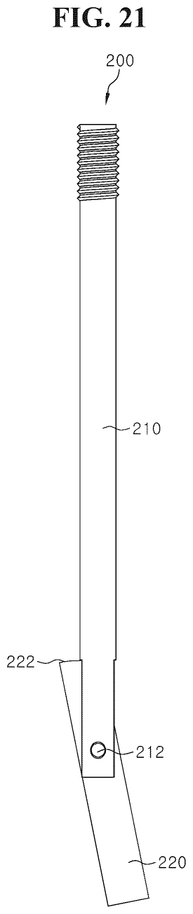

FIG. 21 is a diagram illustrating the inserted state of the T-bolt according to the fifth embodiment of the present invention.

Referring to FIGS. 20 and 21, the lower horizontal part 220 may be connected to the upper vertical part 210 around the pivot pin 212 so that one side of the lower horizontal part 220 has a shorter length than the other side. Therefore, when the lower horizontal part 220 rotates from the fixed state in FIG. 20 to the inserted state in FIG. 21, one side of the lower horizontal part 220 can be rotated so that it faces upward and the other side faces downward. In other words, when the lower horizontal part 220 is in the inserted state, one side of the lower horizontal part 220 can always be inserted into the pivot groove 211.

Additionally, the end of one side of the lower horizontal part 220 that has a shorter length than the other side may have a round part 222 that is sloped from the top to the bottom. Therefore, when the lower horizontal part 220 is rotated and inserted into the pivot groove 211 in the inserted state, the round part 222 of the lower horizontal part 220 can be inserted into the pivot groove 211. In this case, since the pivot groove 211 is formed to have a shorter length than one side of the lower horizontal part 220, only the round part 222 on one side is inserted into the pivot groove 211 as shown in FIG. 21, and the remaining part is engaged with the pivot groove 211, causing a specific part of the lower horizontal part 220 to protrude from the pivot groove 211. Thus, the specific part on one side of the lower horizontal part 220 can be secured in a protruding state.

As an example of operation, when the lower horizontal part 220 rotates from the fixed state in FIG. 20 to the inserted state in FIG. 21, the side with the short length can always rotate to face the pivot groove 211, and the lower horizontal part 220 can be secured to the upper vertical part 210 by the round part 222 on one side when it is inserted into the pivot groove 211. Moreover, when the lower horizontal part 220 rotates from the inserted state in FIG. 21 to the fixed state in FIG. 20, the lower horizontal part 220 can always rotate in the opposite direction of the rotation required for the inserted state. In other words, the lower horizontal parts 220 can always rotate in the same direction respectively each time it transitions to either the fixed state or the inserted state. Therefore, since the worker can infer the rotation direction of the lower horizontal part 220 when mounting the T-bolt 200 to the hole guard 100, it is possible to easily rotate the lower horizontal part 220 in the desired direction, thus reducing the work time.

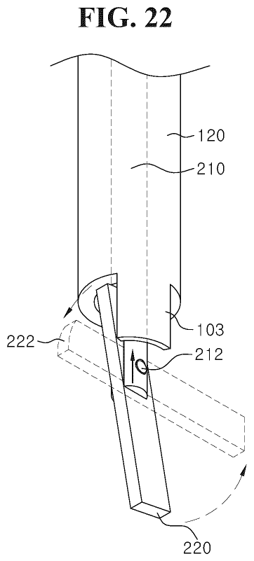

FIG. 22 is a diagram illustrating a method of coupling the hole guard according to the third embodiment of the present invention and the T-bolt according to the fifth embodiment.

Referring to FIG. 22, first, the T-bolt 200 can be inserted into the hole insertion part 120 of the hole guard 100 in an inserted state where the lower horizontal part 220 is inserted into the pivot groove 211. At this time, the T-bolt 200 can be lowered until the entire lower horizontal part 220 is exposed from the hole insertion part 120. When the lower horizontal part 220 is lowered, the worker can move the T-bolt 200 upward in a state where a portion of the lower horizontal part 220 protruding from the pivot groove 211 is in contact with the lower surface of the hole insertion part 120. In other words, as shown in FIG. 22, by moving the T-bolt 200 upward, one side of the lower horizontal part 220 can slide along the round part 222 while it is in contact with the lower surface of the hole insertion part 120, allowing the lower horizontal part 220 to rotate naturally. Therefore, in order to change the lower horizontal part 220 from the inserted state to the fixed state, an operation such as shaking the T-bolt 200 is not required, making it easy to transition to the fixed state.

Still referring to FIGS. 16 and 17, the anti-falling washer 300 can be inserted into the T-bolt 200 and mounted on the upper vertical part 210. That is, the T-bolt 200 with the anti-falling washer 300 mounted thereon can be inserted into the bolt hole 101 of the hole guard 100, and then the anti-falling washer 300 can be arranged to be supported on the upper surface of the hole guard 100, making it possible to prevent the T-bolt 200 from falling below the lower structure S.

The bracket 500 may be placed on the anti-falling washer 300. As can be seen from the drawings, the bracket 500 may have an “L” shape, but is not limited thereto. Various other forms can be applied where one side is coupled to the equipment and the other side can be coupled to the supporting part.

The flat washer 600 and the anti-loosening washer 800 may be sequentially arranged on the top of the bracket 500, and the fixing nut 900 may be fastened to the top of the anti-loosening washer 800. After fixing the fixing nut 900, a protruding part may be formed on the surface of the anti-loosening washer 800 to prevent the fixing nut 900 from loosening due to vibration or external shock.

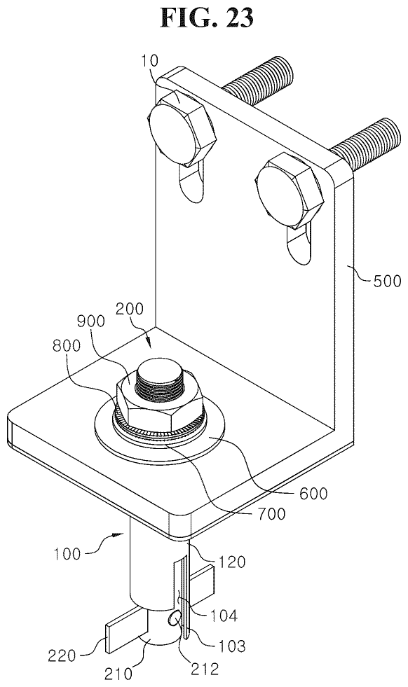

FIG. 23 is a perspective view illustrating another embodiment of the bolt fastening structure using the hole guard of the present invention.

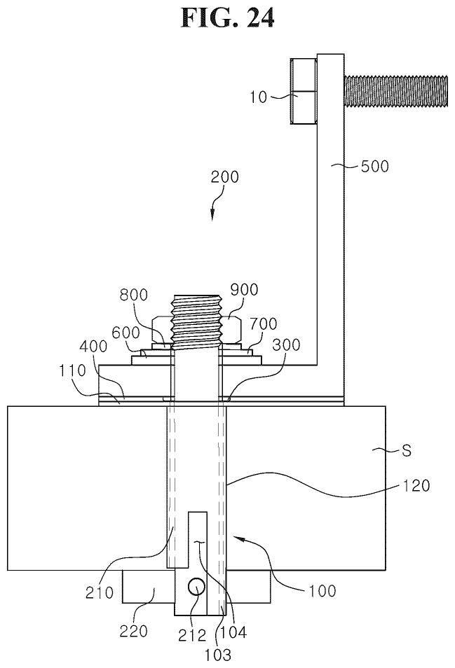

FIG. 24 is a diagram illustrating another embodiment of the bolt fastening structure using the hole guard of the present invention.

Referring to FIGS. 23 and 24, another embodiment of the bolt fastening structure using the hole guard of the present invention may comprise a hole guard 100, a T-bolt 200, an anti-falling washer 300, and a buffer pad 400, a bracket 500, a flat washer 600, a coupling washer 700, an anti-loosening washer 800, and a fixing nut 900.

First, the hole guard 100 may be mounted on a lower structure S of an industrial facility, which has holes formed on the floor for fastening. More specifically, the hole guard 100 can be mounted on, for example, a steel pad S having large holes or elongated holes or a grating plate G where the holes have been damaged and the sizes of the holes are inconsistent, on which the equipment cannot be mounted using only the T-bolt 200.

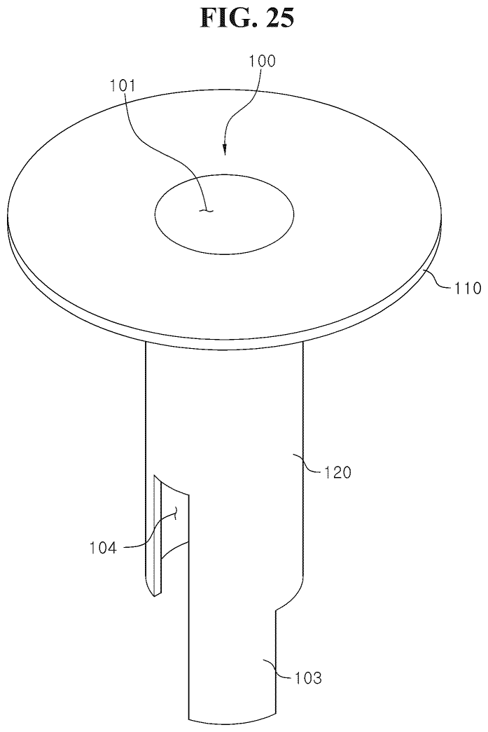

FIG. 25 is a diagram illustrating a hole guard according to the fourth embodiment of the present invention.

Referring to FIG. 25, the hole guard according to the fourth embodiment of the present invention may comprise a plate-shaped support part 110 and a hole insertion part 120 disposed below the support part 110. For example, the support part 110 and the hole insertion part 120 may be integrally formed. A bolt hole 101 may be formed through the support part 110 and the hole insertion part 120 to allow the insertion and mounting of the T-bolt 200. The bolt hole 101 may extend from the support part 110 to the hole insertion part 120. In this case, the bolt hole 101 formed in the hole insertion part 120 may be shaped so that the hole insertion part 120 has an empty cylindrical shape, and the bolt hole 101 formed in the support part 110 may have a circular hole shape to allow the T-bolt 200 to be inserted and secured.

The support part 110 may have a plate shape, which may be either rectangular or circular, and it may be larger than the size of the hole formed in the lower structure S. In other words, the support part 110 may be the portion that is supported on the upper surface of the lower structure S.

The hole insertion part 120 is disposed below the support part 110 and can be inserted into the hole of the lower structure S. The hole insertion part 120 may have a cylindrical shape with a predetermined height. At this time, the hole insertion part 120 may have the same shape and size as the size of the hole formed in the lower structure S. For example, if the hole in the lower structure S has a large circular shape or if the hole has been damaged and expanded, the hole insertion part 120 may be adjusted to the size of the hole formed in the lower structure S or the size of the expanded hole. Depending on the equipment to be secured on the lower structure S, one or more of these hole insertion parts 120 may be disposed below the support part 110.

When the hole insertion part 120 is inserted into the hole of the lower structure S, the hole guard 100 can be supported on the upper surface of the lower structure S by means of the support part 110, making it possible to prevent the hole guard 100 from falling below the lower structure S.

One side of the lower surface of the hole insertion part 120 may comprise a protrusion 103 that protrudes from the lower surface. The protrusion 103 may function to prevent the lower horizontal part 220 of the T-bolt 200 from rotating after the T-bolt 200 is inserted into the hole guard 100. For example, when the lower horizontal part 220 of the T-bolt 200 inserted into the hole guard 100 is rotated around the pivot pin 212 so that it is perpendicular to the upper vertical part 210, the lower horizontal part 220 may be securely engaged with the protrusion 103. In other words, the protrusion 103 allows the T-bolt 200 mounted on the hole guard 100 to be secured in place. Therefore, the worker can quickly and securely fasten the fixing nut 900 to the T-bolt 200 even from the top of the lower structure S.

The protrusion 103 may function to prevent the secured T-bolt 200 from loosening due to vibration or impact. For example, the T-bolt 200 secured to the hole guard 100 may be loosened if the vibration or impact generated from the equipment is transmitted to the lower structure S. However, the T-bolt 200 according to the present invention can be prevented from rotating by the protrusion 103, making it possible to prevent the T-bolt 200 from loosening due to the vibration or impact. For example, even when the fixing nut 900 is to be released, the lower horizontal part 220 can be secured by the protrusion 103, allowing the worker to quickly and securely release the fixing nut 900 from the top of the lower structure S without separately securing the T-bolt 200.

Furthermore, the hole guard 100 according to the fourth embodiment may comprise a protruding groove 104 formed on the lower side of the hole insertion part 120. The protruding groove 104 allows the lower horizontal part 220 of the T-bolt 200 inserted into the hole insertion part 120 to protrude from the side of the hole insertion part 120.

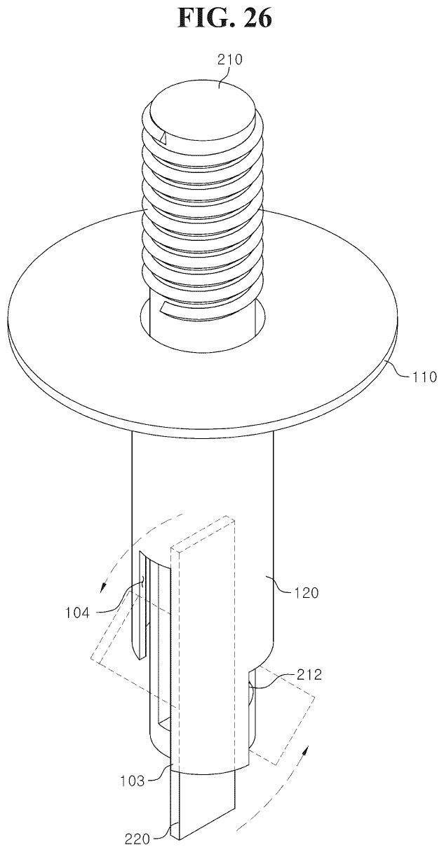

FIG. 26 is a diagram illustrating a method of coupling the T-bolt using the hole guard according to the fourth embodiment of the present invention.

Referring to FIG. 26, the T-bolt 200 fastened to the hole guard according to the fourth embodiment may be the pivotable T-bolt 200 according to the third and fourth embodiments shown in FIGS. 9 to 11. That is, the T-bolt 200 can be inserted into the hole guard 100 in an inserted state where the lower horizontal part 220 is inserted into the pivot groove 211. In this case time, the lower horizontal part 220 can be inserted into to the protruding groove 104 formed on the lower side of the hole insertion part 120, and as shown in FIG. 26, the lower horizontal part 220 can rotate to protrude through the protruding groove 104 towards the side of the hole insertion part 120. Therefore, the lower horizontal part 220 can rotate through the protruding groove 104 to change to a fixed state where it is perpendicular to the upper vertical part 210.

In other words, to rotate the lower horizontal part 220, there is no need to insert the lower horizontal part 220 deeply into the lower surface of the hole insertion part 120, and it is possible to rotate the lower horizontal part 220 exposed through the protruding groove 104 during insertion, allowing the lower horizontal part 220 to be quickly changed to the fixed state. Moreover, when it is intended to change the lower horizontal part 220 from the fixed state to the inserted state, it can be changed to the inserted state by rotating the lower horizontal part 220 at the position of the protruding groove 104, allowing the T-bolt 200 to be quickly removed from the hole guard 100. This protruding groove 104 can allow the lower horizontal part 220 to be rotated even when it is only partially inserted into the hole guard 100, allowing the length of the T-bolt 200 to be reduced.

Due to the protruding groove 104, the lower horizontal part 220, which is perpendicular to the upper vertical part 210, can be rotated around the upper vertical part 210 and securely engaged with the protrusion 103. Furthermore, in order to change the lower horizontal part 220 to the inserted state, the lower horizontal part 220 can be rotated in the opposite direction to be placed at the position of the protruding groove 104.

Still referring to FIGS. 23 and 24, the anti-falling washer 300 can be inserted into the T-bolt 200 and mounted on the upper vertical part 210. That is, the T-bolt 200 with the anti-falling washer 300 mounted thereon can be inserted into the bolt hole 101 of the hole guard 100, and then the anti-falling washer 300 can be arranged to be supported on the upper surface of the hole guard 100, making it possible to prevent the T-bolt 200 from falling below the lower structure S.

The bracket 500 may be placed on the anti-falling washer 300. As can be seen from the drawings, the bracket 500 may have an “L” shape, but is not limited thereto. Various other forms can be applied where one side is coupled to the equipment and the other side can be coupled to the supporting part.

In this case, a buffer pad 400 with a washer hole may be provided between the bracket 500 and the lower structure S. The buffer pad 400 may be disposed on the hole guard 100 so that the anti-falling washer 300 is inserted into the washer hole. Therefore, the buffer pad 400 can prevent the vibration from the lower structure S from being transmitted upwards, and the anti-falling washer 300 can prevent the bracket 500 from being structurally lifted.

The flat washer 600, the coupling washer 700, and the anti-loosening washer 800 are sequentially disposed on the top the bracket 500, and the fixing nut 900 is fastened to the top of the anti-loosening washer 800. After fastening the fixing nut 900, a protruding part may be formed on the surface of the anti-loosening washer 800 to prevent the fixing nut 900 from loosening due to vibration or external shock.

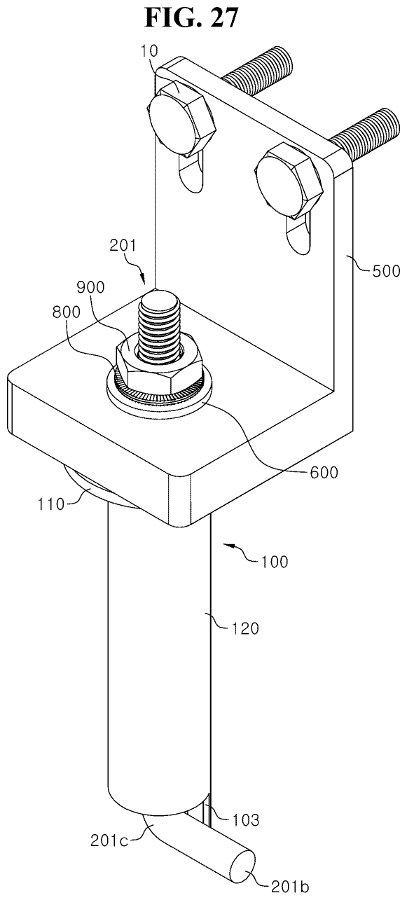

FIG. 27 is a perspective view illustrating another embodiment of the bolt fastening structure using the hole guard of the present invention.

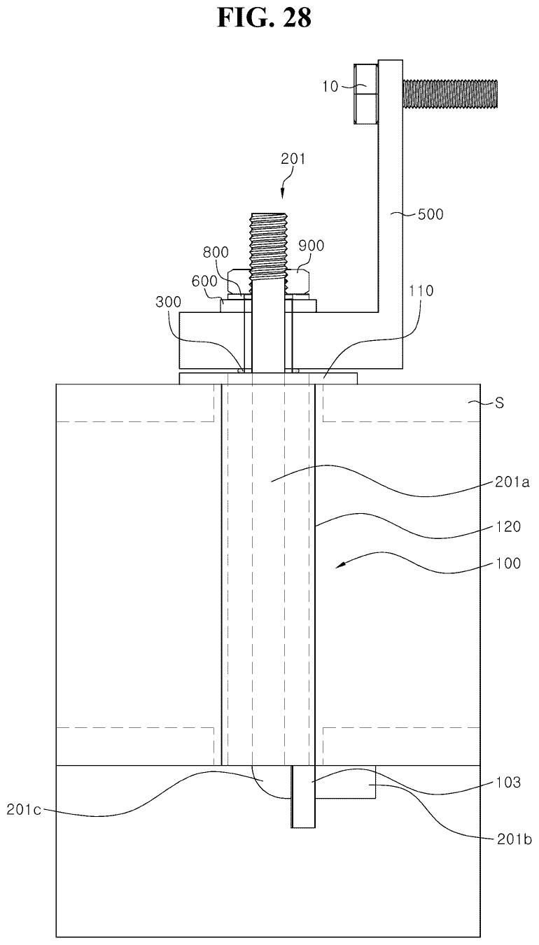

FIG. 28 is a diagram illustrating another embodiment of the bolt fastening structure using the hole guard of the present invention.

Referring to FIGS. 27 and 28, another embodiment of the bolt fastening structure using the hole guard of the present invention may comprise a hole guard 100, an L-bolt 201, an anti-falling washer 300, a bracket 500, a flat washer 600, an anti-loosening washer 800, and a fixing nut 900.

First, the hole guard 100 according to the third embodiment can be used. That is, the hole guard 100 may comprise a plate-shaped support part 110 and a hole insertion part 120 disposed below the support part 110. For example, the support part 110 and the hole insertion part 120 may be integrally formed. A bolt hole 101 may be formed through the support part 110 and the hole insertion part 120 to allow the insertion and mounting of the L-bolt 201. The bolt hole 101 may extend from the support part 110 to the hole insertion part 120.

Additionally, one side of the lower surface of the hole insertion part 120 may comprise a protrusion 103 that protrudes from the lower surface. The protrusion 103 may function to prevent the lower horizontal part 201b of the L-bolt 201 from rotating after the L-bolt 201 is inserted into the hole guard 100. For example, when the upper vertical part 201a of the L-bolt 201 is inserted into the hole guard 100, the lower horizontal part 201b may be securely engaged with the protrusion 103, allowing the L-bolt 201 to be secured to the hole guard 100.

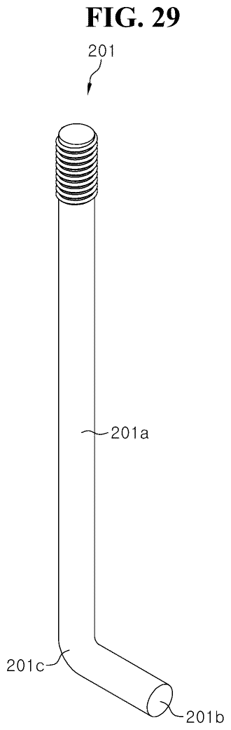

FIG. 29 is a diagram illustrating the L-bolt of the present invention.

Referring to FIG. 29, the L-bolt 201 according to the present invention may have an “L” shape and comprise an upper vertical part 201a, a lower horizontal part 201b, and a bent part 201c. The lower horizontal part 201b may extend downward from the upper vertical part 201a through the bent part 201c.

The upper vertical part 201a is the portion that penetrates the lower structure S, the bracket 500 placed thereon, and a fastening hole provided by the fastening elements, and has a threaded groove, onto which the fixing nut 900 is secured. That is, the upper vertical part 201a may be the portion that is exposed above the hole guard 100 when the L-bolt 201 is mounted on the hole guard 100. Therefore, by fastening the fixing nut 900 to the exposed upper vertical part 201a, the bracket 500 can be secured to the lower structure S.

The lower horizontal part 201b may be the portion that is inserted into the bolt hole 101 of the hole guard 100 and located below the lower structure G to be pressed against the lower surface of the lower structure S

The lower horizontal part 201b may be the portion that is inserted into the bolt hole 101 of the hole guard 100 and located below the lower structure S to be pressed against the lower surface of the hole guard 100 when the L-bolt 201 is mounted on the hole guard 100. That is, the lower horizontal part 201b can be engaged with the protrusion 103 of the hole guard 100, thus allowing the L-bolt 201 to be secured upright within the hole guard 100.

However, when mounting the L-bolt 201 to the hole guard 100, the upper vertical part 201a of the L-bolt 201 can be inserted into the hole guard 100 from the bottom to the top by the bent lower horizontal part 201b, allowing the L-bolt 201 to be mounted on the hole guard 100. For example, when mounting the hole guard 100 to the lower structure S, the L-bolt 201 and the anti-falling washer 300 may first be fastened to the hole guard 100, and in this state, the hole guard 100 may then be inserted into the hole of the lower structure S. Therefore, even when the L-bolt 201 is used for the hole guard 100, the lower horizontal part 201b of the L-bolt 201 can be securely engaged with the protrusion 103 of the hole guard 100 to allow the L-bolt 201 to be secured, just like the T-bolt 200, and thus the worker can quickly and securely fasten the fixing nut 900 to the L-bolt 201 even from the top of the lower structure S. Moreover, even when the fixing nut 900 is to be released, the lower horizontal part 201b can be secured by the protrusion 103, allowing the worker to quickly and securely release the fixing nut 900 from the top of the lower structure S without separately securing the L-bolt 201.

Still referring to FIGS. 27 and 28, the bracket 500 may be placed on the anti-falling washer 300. As can be seen from the drawings, the bracket 500 may have an “L” shape, but is not limited thereto. Various other forms can be applied where one side is coupled to the equipment and the other side can be coupled to the supporting part.

The flat washer 600 and the anti-loosening washer 800 may be sequentially arranged on the top of the bracket 500, and the fixing nut 900 may be fastened to the top of the anti-loosening washer 800. After fixing the fixing nut 900, a protruding part may be formed on the surface of the anti-loosening washer 800 to prevent the fixing nut 900 from loosening due to vibration or external shock.

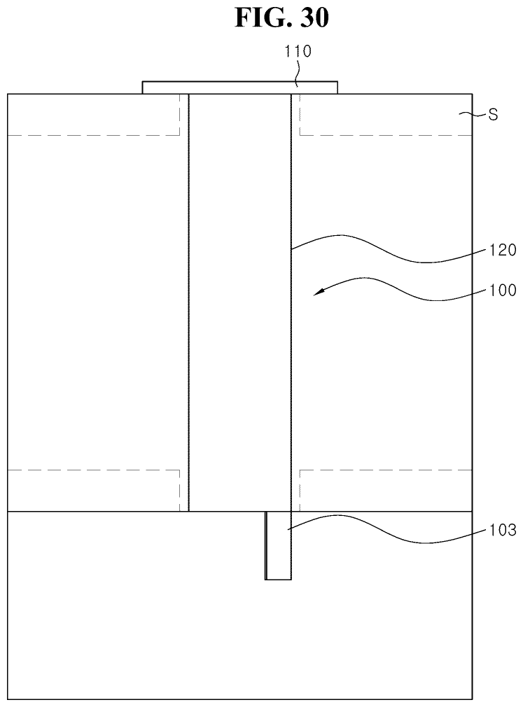

FIGS. 30 to 33 are diagrams illustrating a method of mounting a bolt fastening structure using a hole guard according to the third embodiment of the present invention and the T-bolt according to the fifth embodiment of the present invention.

First, referring to FIG. 30, the hole guard 100 is mounted on a lower structure S such as a steel pad or grating plate where the holes are deep or the hole are spaced apart and formed doubly. The hole insertion part 120 of the hole guard 100 may be selected to have the same size and shape as the hole of the lower structure S. The selected hole insertion part 120 is inserted and mounted into the hole of the lower structure S. At this time, the hole guard 100 can be mounted on the lower structure S with the buffer pad 400 mounted thereon.

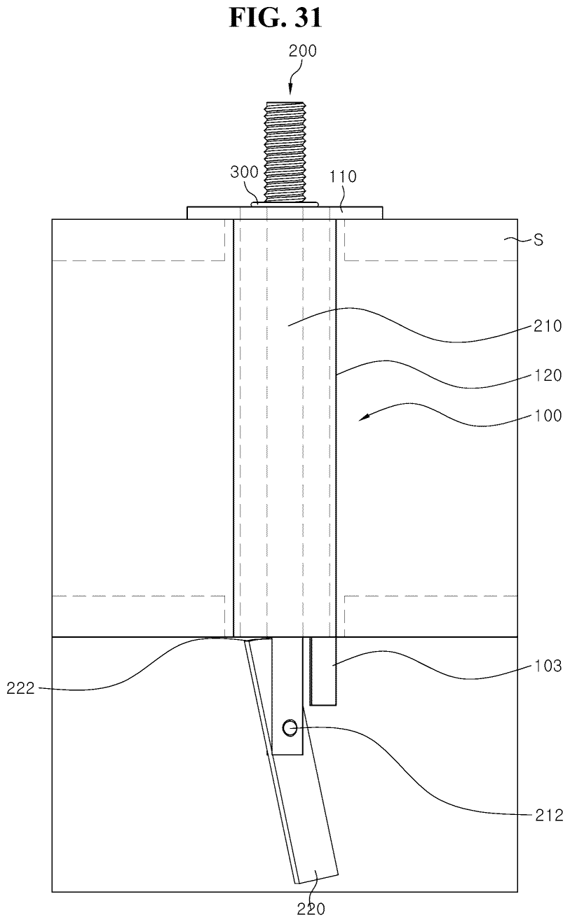

Referring to FIG. 31, the T-bolt 200 with the anti-falling washer 300 mounted thereon is inserted into the hole guard 100. In other words, the T-bolt 200 can be inserted into the hole guard 100 from top of the lower structure S in a state where the lower horizontal part 220 is inserted into the pivot groove 211 of the upper vertical part 210. At this time, the T-bolt 200 can be inserted into the hole guard 100 in such a manner that the lower horizontal part 220 is inserted into the hole insertion part 120 until the entire lower horizontal part 220 is exposed from the hole insertion part 120.

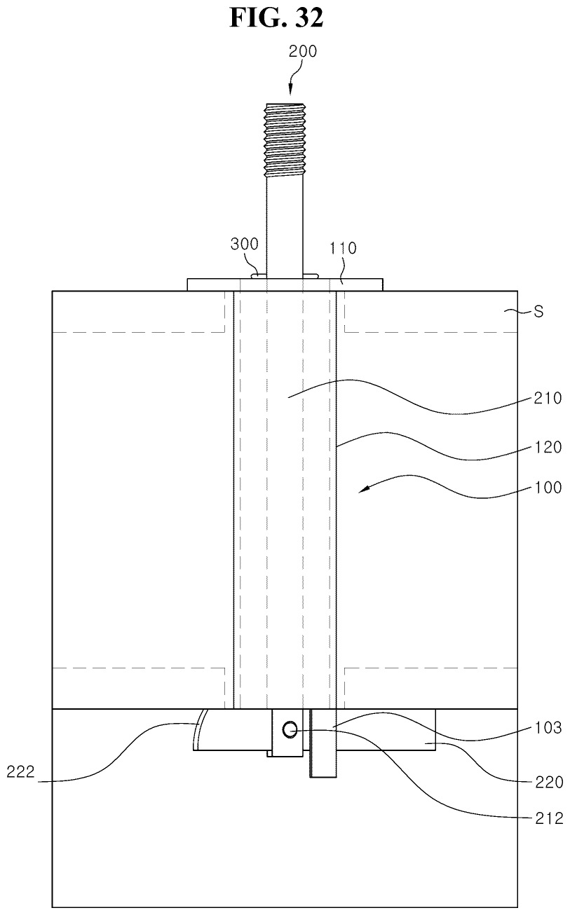

Referring to FIG. 32, the T-bolt 200 inserted into the hole guard 100 is secured to the hole guard 100 by the lower horizontal part 220. That is, after the lower horizontal part 220 is inserted into the hole guard 100, the T-bolt 200 can be moved upward in a state where a portion of the lower horizontal part 220 protruding from the pivot groove 211 is in contact with the lower surface of the hole insertion part 120, allowing one side of the lower horizontal part 220 to slide along the round part 222. By the rotation of the lower horizontal part 220, the upper surface of the lower horizontal part 220 is in contact with the lower structure S, and the side surface of the lower horizontal part 220 is in contact with the protrusion 103 of the hole insertion part 120, allowing the T-bolt 200 to be secured to the hole guard 100. At this time, the T-bolt 200 can be secured by the anti-falling washer 300 to prevent the T-bolt 200 from falling below the lower structure S.

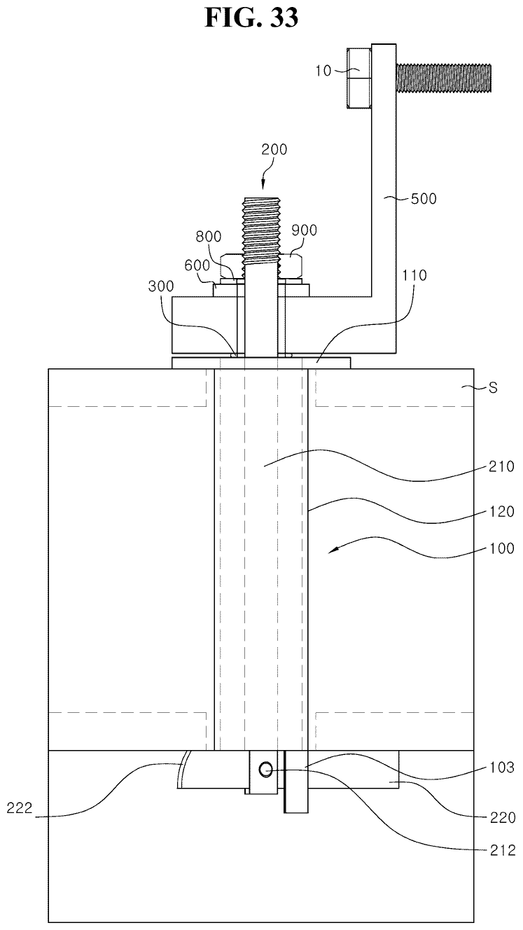

Referring to FIG. 33, the bracket 500 may be disposed on the hole guard 100 and the anti-falling washer 300. Additionally, the flat washer 600, the anti-loosening washer 800, and the fixing nut 900 may be sequentially fastened to the T-bolt 200 exposed above the bracket 500. At this time, by means of the fastened fixing nut 900, the lower horizontal part 220 supports the lower surface of the lower structure S and presses the protrusion 103 of the hole guard 100, allowing the T-bolt 200 fastened to the lower structure S to be firmly secured thereto.

As described above, according to the bolt fastening structure using the hole guard 100 of the present invention, since the bolt is fastened to the hole guard 100 already mounted on the lower structure S, it is possible to fasten the bolt to a steel pad having large holes or elongated holes or a grating plate where the holes have been damaged and the sizes of the holes are inconsistent. Moreover, by forming the locking groove 102, into which the lower horizontal part 220 of the bolt is inserted, or the protruding groove 104 and the protrusion 103 for rotation and fixation of the lower horizontal part 220 on the lower surface of the hole guard 100, both the fixed and pivoting types of the lower horizontal part 220 can be secured upright to the hole guard 100. Furthermore, since the installation of bolt is possible in one direction for holes of various sizes using the hole guard 100 and the T-bolt 200 or L-bolt 201, the bolt fastening structure using the hole guard 100 according to the present invention can be widely used not only on the floor areas of industrial sites but also on H-beam structures at construction sites, as well as for hook hangers on ceilings or wall structures.

Meanwhile, the embodiments of the present invention disclosed in this specification and drawings are merely examples provided to aid understanding and are not intended to limit the scope of the present invention. It is obvious to those skilled in the art that other variations based on the technical idea of the present invention can be implemented in addition to the embodiments disclosed herein.

Brief Description of Reference Numerals

| | |
|---|---|
| 100: hole guard | 101: bolt hole |
| 102: locking groove | 103: protruding part |
| 104: protruding groove | 110: support part |
| 120: hole insertion part | 200: T-bolt |
| 201: L-bolt | 201a, 210: upper vertical part |
| 211: pivot groove | 212: pivot pin |
| 201b, 220: lower horizontal part | 201c: bent part |
| 221: protruding part | 222: round part |
| 300: anti-falling washer | 400: buffer pad |
| 500: bracket | 600: flat washer |
| 700: coupling washer | 800: anti-loosening washer |
| 900: fixing nut | |

What is claimed is:

1. A bolt fastening structure using a hole guard comprising:
a lower structure which is located below the equipment of an industrial facility and has holes for fastening;
a hole guard which is inserted and secured into the hole of the lower structure;
a T-bolt comprising an upper vertical part which has threads formed thereon and a lower horizontal part which is formed to have a predetermined length on both sides around the upper vertical part, the T-bolt being inserted and fastened into the hole guard; and
a ring-shaped anti-falling washer which is fastened to the T-bolt and supported on the hole guard to prevent the T-bolt from falling below the lower structure.

2. The bolt fastening structure using the hole guard of claim 1, wherein the hole guard comprises:
a support part which is disposed on the lower structure;
a hole insertion part which is disposed below the support part and inserted into the hole of the lower structure; and
a bolt hole which is formed through the support part and the hole insertion part to allow the insertion of the T-bolt.

3. The bolt fastening structure using the hole guard of claim 2, wherein the hole insertion part has an outer diameter that is the same as the inner diameter of the hole formed in the lower structure.

4. The bolt fastening structure using the hole guard of claim 2, wherein the lower surface of the hole insertion part comprises a locking groove to allow the T-bolt inserted into the hole guard to be secured to the hole guard.

5. The bolt fastening structure using the hole guard of claim 4, wherein the locking groove is formed on both sides of the lower surface of the hole insertion part around the bolt hole.

6. The bolt fastening structure using the hole guard of claim 4, wherein the locking groove has a width greater than the thickness of the lower horizontal part.

7. The bolt fastening structure using the hole guard of claim 2, wherein the bolt hole has an elongated hole shape such that the lower horizontal part passes through the hole insertion part when the lower horizontal part of the T-bolt is inserted into the hole guard.

8. The bolt fastening structure using the hole guard of claim 2, wherein one side of the lower surface of the hole insertion part comprises a protrusion to allow the T-bolt inserted into the hole guard to be secured to the hole guard.

9. The bolt fastening structure using the hole guard of claim 2, wherein the lower side of the hole insertion part comprises a protruding groove to allow the lower horizontal part inserted into the hole insertion part to protrude from the side of the hole insertion part.

10. The bolt fastening structure using the hole guard of claim 1, wherein the lower horizontal part is formed integrally with the upper vertical part and has the same length on both sides around the upper vertical part.

11. The bolt fastening structure using the hole guard of claim 1, wherein the lower horizontal part is formed integrally with the upper vertical part and has different lengths from each other around the upper vertical part.

12. The bolt fastening structure using the hole guard of claim 2, wherein both sides of the lower horizontal part have a protruding part of which one or both sides protrude from the hole insertion part around the upper vertical part so that the lower horizontal part is in contact with the lower structure.

13. The bolt fastening structure using the hole guard of claim 1, wherein the lower horizontal part is connected to the bottom of the upper vertical part by means of a pivot pin so that the lower horizontal part is pivoted at the bottom of the upper vertical part.

14. The bolt fastening structure using the hole guard of claim 13, wherein the upper vertical part comprises a pivot groove to allow the lower horizontal part to be inserted into the upper vertical part when the lower horizontal part is pivoted.

15. The bolt fastening structure using the hole guard of claim 14, wherein the lower horizontal part is connected to the upper vertical part by the pivot pin so that one side of the lower horizontal part has a shorter length than the other side around the pivot pin.

16. The bolt fastening structure using the hole guard of claim 15, wherein the end of one side of the lower horizontal part comprises a round part that is sloped from the top to the bottom.

17. The bolt fastening structure using the hole guard of claim 15, wherein the pivot groove has a depth shorter than the lengths of both sides of the lower horizontal part.

18. The bolt fastening structure using the hole guard of claim 13, wherein the lower horizontal part has:
an inserted state where the lower horizontal part is inserted into the pivot groove to allow the T-bolt to be inserted to the hole guard; and
a fixed state where after the T-bolt is inserted into the hole guard, the lower horizontal part is pivoted perpendicular to the upper vertical part to allow the T-bolt to be secured to the hole guard.

19. A bolt fastening structure using the hole guard comprising:
a lower structure which is located below the equipment of an industrial facility and has holes for fastening;
a hole guard which has an outer diameter that is the same as the inner diameter of the hole formed in the lower structure and is inserted and secured into the hole of the lower structure;
an L-bolt comprising an upper vertical part which has threads formed thereon and a lower horizontal part which is formed to extend to the bottom of the upper horizontal part through a bent part; and
a ring-shaped anti-falling washer which is fastened to the L-bolt and supported on the hole guard to prevent the L-bolt from falling below the lower structure,
wherein the hole guard comprises:
a support part which is disposed on the lower structure;
a hole insertion part which is disposed below the support part and inserted into the hole of the lower structure; and
a bolt hole which is formed through the support part and the hole insertion part to allow the insertion of the L-bolt.

20. The bolt fastening structure using the hole guard of claim 19, wherein one side of the lower surface of the hole insertion part comprises a protrusion to allow the L-bolt inserted into the hole guard to be secured to the hole guard.
